(19) United States
(12) Patent Application Publication
(10) Pub. No.: US 2010/0017486 A1
(43) Pub. Date: Jan. 21, 2010

(54) SYSTEM ANALYZING PROGRAM, SYSTEM ANALYZING APPARATUS, AND SYSTEM ANALYZING METHOD

(75) Inventor: Ken Yokoyama, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/436,518

(22) Filed: May 6, 2009

(30) Foreign Application Priority Data
Jul. 16, 2008 (JP) 2008-184591

(51) Int. Cl. G06F 15/16

(52) U.S. Cl. 709/206

(57) ABSTRACT

A system analyzing apparatus obtains a message group including a message ID, a protocol, a type, and a transmission time of messages transmitted/received in a system where a hierarchical structure of protocols is defined. The apparatus detects pairs of a request message and a response message of the same message ID from the obtained message group. The apparatus identifies a request time and a response time of each of the detected pairs. The apparatus searches for a child-layer pair that has a request time and a response time between the request time and the response time of a parent-layer pair arbitrarily selected from among the pairs and that has a protocol in a layer lower than the protocol of the parent-layer pair on the basis of the identified result. The apparatus outputs the found child-layer pair as a candidate pair having a call relationship with the parent-layer pair.

### CROSS-REFERENCE TO RELATED APPLICATIONS

This application is based upon and claims the benefit of priority of the prior Japanese Patent Application No. 2008-184591, filed on Jul. 16, 2008, the entire contents of which are incorporated herein by reference.

### FIELD

The disclosed technique relates to a technique of analyzing operation statuses of servers in a network system where a hierarchical structure of communication protocols is defined.

### BACKGROUND

In recent years, it has become difficult to properly recognize operation statuses and problems in the performance of large-scale and complicated network systems. This is because, in a complicated network system in which a plurality of applications operate in conjunction with each other, the performance of the entire system in addition to the behavior of each server needs to be observed and analyzed in order to determine the cause of degradation in performance and failure.

Under such circumstances, there has been disclosed a conventional technique of recognizing a specific operation status of a target system and quickly solving a problem in performance by analyzing the operation status of an entire network system by using a transaction model that defines the transmission/reception of messages among a plurality of servers in the network system.

The above-described related art involves the necessity to create a transaction model for analyzing the system in advance. However, creation of the transaction model requires specific information of messages and verification depending on the knowledge and know-how of an operator. Accordingly, the time and load of an analyzing operation increase which results in a disadvantageous increase in introduction cost for system analysis.

The disclosed technique addresses the above-described problems of the related art and easily analyzes operation statuses of servers in a system without the need to create a transaction model in advance.

### SUMMARY

A system analyzing apparatus obtains a message data group including a message ID, a protocol, a type, and a transmission time of each of messages transmitted/received in a system where a hierarchical structure of protocols is defined. The apparatus detects pairs of a request message and a response message of the same message ID from the obtained message data group. The apparatus identifies a request time and a response time of each of the detected pairs. The apparatus searches for a child-layer pair that has a request time and a response time between the request time and the response time of a parent-layer pair arbitrarily selected from among the pairs and that has a protocol in a layer lower than the protocol of the parent-layer pair on the basis of the identified result. The apparatus outputs the found child-layer pair as a candidate pair having a call relationship with the parent-layer pair.

### BRIEF DESCRIPTION OF DRAWINGS

FIG. 1 illustrates a configuration of a network system;

FIG. 2 illustrates an outline of a capture function;

FIG. 3 illustrates content stored in a packet DB;

FIG. 4 is a block diagram illustrating a hardware configuration of a system analyzing apparatus;

FIG. 5 is a block diagram illustrating a functional configuration of the system analyzing apparatus;

FIG. 6 illustrates an example of hierarchical structure definition information;

FIG. 7 illustrates content stored in a message DB;

FIG. 8 illustrates an example of a pair information table;

FIG. 9 illustrates an outline of a searching process;

FIG. 10 illustrates content stored in a parent-child relationship table;

FIG. 11 illustrates an example of a transaction model;

FIG. 12 illustrates an example of a response period table;

FIG. 13A illustrates an outline of a calculating process of calculating processing periods of servers;

FIG. 13B illustrates an outline of the calculating process of calculating processing periods of servers;

FIG. 14 illustrates a first example of an output result;

FIG. 15 illustrates a second example of the output result;

FIG. 16 illustrates a third example of the output result;

FIG. 17 is a flowchart illustrating an example of a procedure of a system analyzing process;

FIG. 18 is a flowchart illustrating a procedure of a searching process; and

FIG. 19 is a flowchart illustrating a procedure of a calculating process.

### DESCRIPTION OF EMBODIMENTS

Hereinafter, an embodiment is described in detail with reference to the attached drawings. The disclosed technique analyzes an operation status of each server by analyzing a parent-child relationship between messages transmitted/received in a system where a hierarchical structure of protocols is defined and by estimating a response period in units of layers on the basis of a response period of each message.

### (Configuration of Network System)

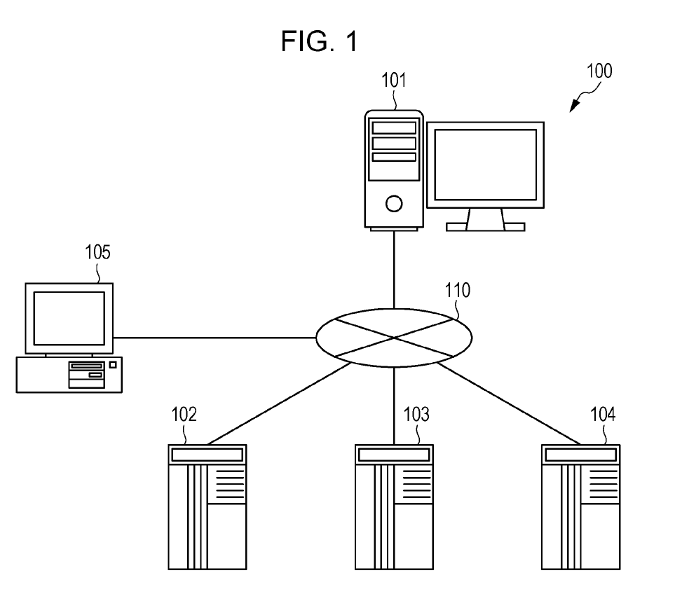

First, a configuration of a network system according to the embodiment is described. FIG. 1 illustrates the configuration of the network system. Referring to FIG. 1, the network system 100 includes a system analyzing apparatus 101, a web server 102, an AP (application) server 103, a DB (database) server 104, and a client terminal 105, which are mutually connected via a network 110, such as the Internet, a LAN (Local Area Network), or a WAN (Wide Area Network), so that they can communicate with each other.

A hierarchical structure of protocols is defined in the network system 100. For example, HTTP (HyperText Transfer Protocol) is defined in a first layer as the highest layer. The HTTP is a protocol used in communication between the client terminal 105 and the web server 102.

IIOP (Internet Inter-ORB Protocol) is defined in a second layer. The IIOP is a protocol used in communication between the web server 102 and the AP server 103. SQL (Structured Query Language) is defined in a third layer as a lowest layer. The SQL is a protocol used in communication between the AP server 103 and the DB server 104.

The system analyzing apparatus 101 is a computer apparatus that analyzes messages transmitted/received in the network system 100 and that analyzes operation statuses of the servers in the network system 100 (web server 102, AP server 103, and DB server 104).

The web server 102 is a computer apparatus that transmits an HTML (HyperText Markup Language) file in response to a request from a browser installed in the client terminal 105. The AP server 103 is a computer apparatus that functions as an interface between the web server 102 and the DB server 104 and that controls searching and updating of a database.

The DB server 104 is a computer apparatus that executes the searching and updating of the database. For simplicity, FIG. 1 illustrates one web server 102, one AP server 103, one DB server 104, and one client terminal 105.

### (Outline of Capture Function)

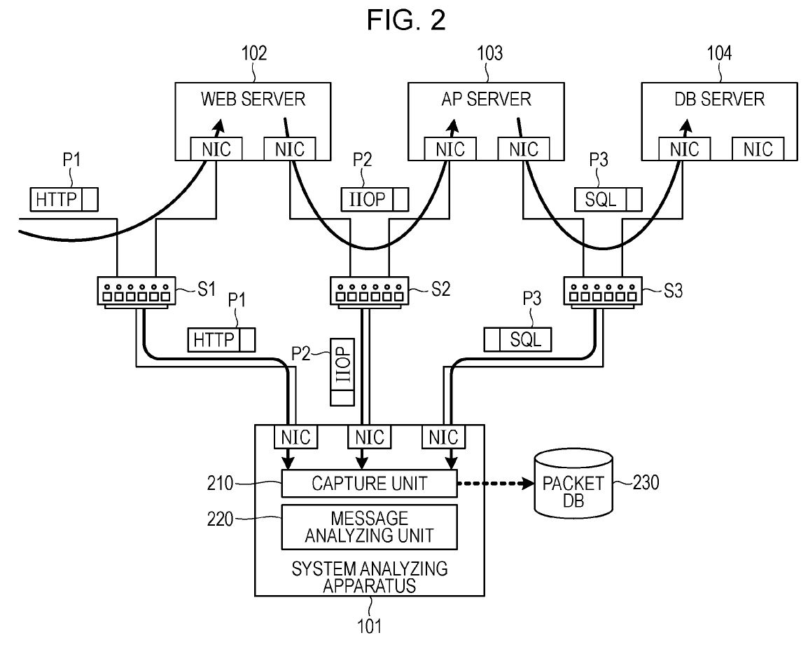

Next, a capture function of the system analyzing apparatus 101 is described. FIG. 2 illustrates an outline of the capture function. Referring to FIG. 2, packets P1 to P3 of the respective protocols (HTTP, IIOP, and SQL) are transmitted/received among the web server 102, the AP server 103, and the DB server 104 via switches S1 to S3 provided in the network 110 (see FIG. 1).

Here, the system analyzing apparatus 101, the web server 102, the AP server 103, and the DB server 104 are coupled to respective ports of the switches S1 to S3. Those switches S1 to S3 have a function of mirroring data passing there through. Mirroring is a function of outputting data that is the same as the data output from a certain port from another port.

Here, the ports coupled to the system analyzing apparatus 101 are designated as mirroring destinations of the ports coupled to the web server 102, the AP server 103, and the DB server 104. Thus, packets addressed to the respective servers are input to the respective servers and are also input to the system analyzing apparatus 101.

For example, assume the case where the web server 102, the AP server 103, and the DB server 104 provide a service in conjunction with each other in response to a request from the client terminal 105 (see FIG. 1). In this case, a packet P1 is transmitted from the client terminal 105 to the web server 102.

At this time, a packet P1 having the same content as that of the packet P1 is input to the system analyzing apparatus 101. A packet P2 is transmitted from the web server 102 to the AP server 103, and a packet P2 having the same content as that of the packet P2 is input to the system analyzing apparatus 101. Furthermore, a packet P3 is transmitted from the AP server 103 to the DB server 104, and a packet P3 having the same content as that of the packet P3 is input to the system analyzing apparatus 101.

The packets P1 to P3 input to the system analyzing apparatus 101 are captured by a capture unit 210 coupled to the switches S1 to S3 and are stored in a packet DB 230. At this time, the capture unit 210 stores the packets P1 to P3 transmitted from the switches S1 to S3 in the packet DB 230, together with time stamps (receipt times).

Alternatively, the capture unit 210 may transmit the captured packets P1 to P3 to a message analyzing unit 220 (the details are described below) without storing the packets P1 to P3 in the packet DB 230. Alternatively, the capture unit 210 may capture only a random packet. Furthermore, only desired data may be selected and mirrored in the switches S1 to S3.

### (Content Stored in Packet DB)

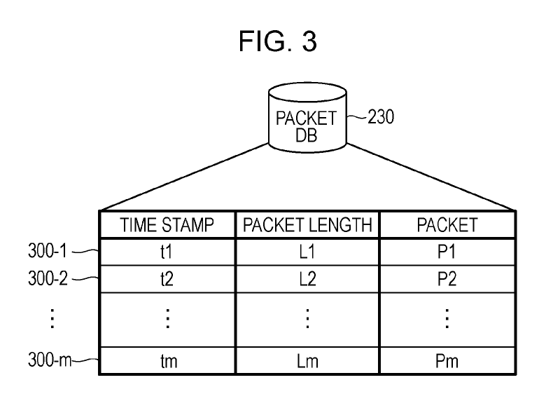

Now, content stored in the packet DB 230 is described. FIG. 3 illustrates the content stored in the packet DB 230. Referring to FIG. 3, the packet DB 230 stores packet data 300-1 to 300-m corresponding to the packets P1 to Pm captured by the capture unit 210 (see FIG. 2).

For example, packet data 300-1 to 300-m is composed of a time stamp, a packet length, and a packet. For example, the packet data 300-1 may include a time stamp t1, a packet length L1, and a packet P1.

### (Hardware Configuration of System Analyzing Apparatus)

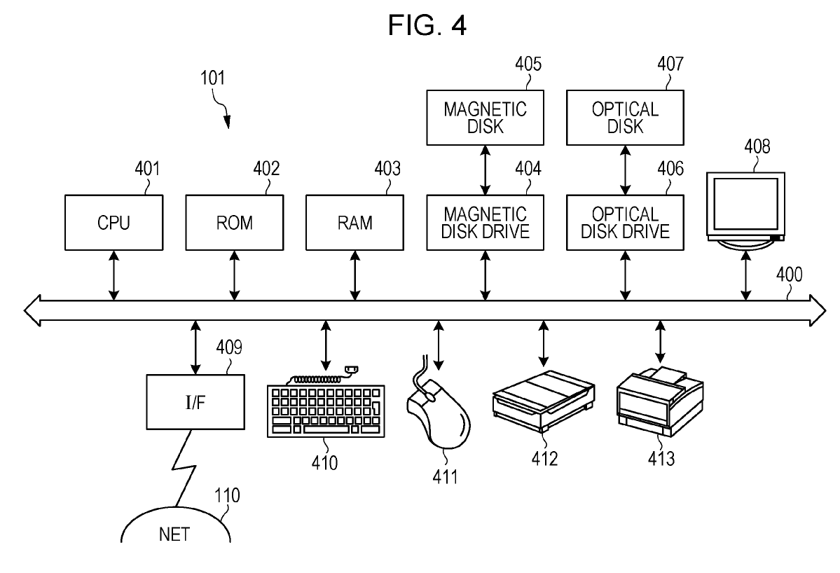

Next, a hardware configuration of the system analyzing apparatus 101 according to the embodiment is described. FIG. 4 is a block diagram illustrating a hardware configuration of the system analyzing apparatus 101. Referring to FIG. 4, the system analyzing apparatus 101 includes a CPU (Central Processing Unit) 401, a ROM (Read Only Memory) 402, a RAM (Random Access Memory) 403, a magnetic disk drive 404, a magnetic disk 405, an optical disk drive 406, an optical disk 407, a display 408, an I/F (interface) 409, a keyboard 410, a mouse 411, a scanner 412, and a printer 413. The respective units are mutually connected via a bus 400.

The CPU 401 controls the entire system analyzing apparatus 101. The ROM 402 stores programs, such as a boot program. The RAM 403 may be used as a work area of the CPU 401. The magnetic disk drive 404 controls read/write of data from/on the magnetic disk 405 in accordance with control by the CPU 401. The magnetic disk 405 stores data written under control by the magnetic disk drive 404.

The optical disk drive 406 controls read/write of data from/on the optical disk 407 in accordance with control by the CPU 401. The optical disk 407 stores data written under control by the optical disk drive 406 and allows a computer to read the data stored in the optical disk 407.

The display 408 displays a cursor, icons, tool boxes, and data such as a document, an image, or function information. As the display 408, a CRT (Cathode Ray Tube), a TFT (Thin-Film Transistor) liquid crystal display, or a plasma display may be adopted.

The interface (hereinafter referred to as I/F) 409 is connected to the network 110, such as a LAN, a WAN, or the Internet, via a communication line. Also, the I/F 409 may be connected to another apparatus via the network 110. Also, the I/F 409 manages the interface between the network 110 and the inside of the apparatus and controls input/output of data from/to an external apparatus. A modem or a LAN adaptor may be adopted as the I/F 409.

The keyboard 410 includes keys to input characters, numerals, and various instructions, and is used to input data. Alternatively, a touch-panel-type input pad or a numeric keypad may be used. The mouse 411 may be used to move the cursor, select a range, move a window, or change a size. Alternatively, a trackball or a joystick may be used as long as those devices are able to function as a pointing device.

The scanner 412 optically reads an image and captures image data into the system analyzing apparatus 101. The scanner 412 may have an OCR (Optical Character Reader) function. The printer 413 prints image data and document data. A laser printer or an inkjet printer may be adopted as the printer 413.

### (Functional Configuration of System Analyzing Apparatus)

Next, a functional configuration of the system analyzing apparatus 101 is described. In the embodiment, processing periods of respective servers of requests that occur in a certain time unit (e.g., in units of hours or in units of days) are totaled for each address (e.g., URL: Uniform Resource Locator), whereby a simple average processing period of the servers may be statistically calculated for each address.

First, a description is given about a method for calculating the processing periods of the web server 102, the AP server 103, and the DB server 104 when a random address (e.g., URL1 or URL2 described below) is designated. Eventually, the processing periods of the respective servers in a certain time unit are totaled for each address and the average of the processing periods is calculated, whereby a simple average processing period of a server may be statistically calculated for each address.

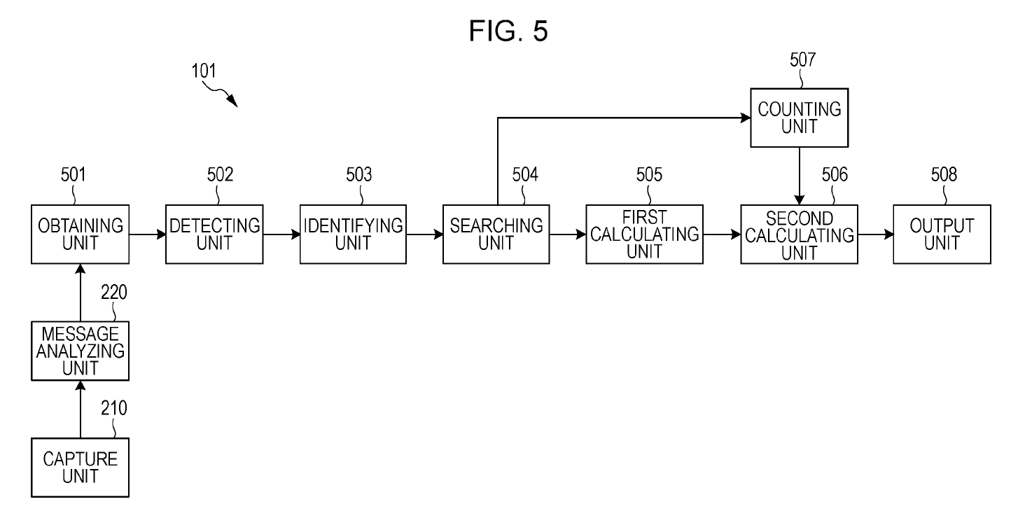

FIG. 5 is a block diagram illustrating a functional configuration of the system analyzing apparatus 101. The system analyzing apparatus 101 includes the capture unit 210, the message analyzing unit 220, an obtaining unit 501, a detecting unit 502, an identifying unit 503, a searching unit 504, a first calculating unit 505, a second calculating unit 506, a counting unit 507, and an output unit 508.

These functions (capture unit 210, message analyzing unit 220, and obtaining unit 501 to output unit 508) serving as a control unit may be realized by allowing the CPU 401 to execute a program stored in a storage area, such as the ROM 402, RAM 403, magnetic disk 405, or optical disk 407 illustrated in FIG. 4, or by the I/F 409, for example. Also, the functions of the units at connected ends indicated by arrows in FIG. 5 are realized by reading data output from the functions at connected sources from the storage area and by allowing the CPU 401 to execute the program related to the functions.

The obtaining unit 501 obtains a message data group which includes a message ID, a protocol, a type of message, and a transmission time of each message transmitted/received among the computer apparatuses (e.g., web server 102, AP server 103, DB server 104, and client terminal 105) in the network system 100 where a hierarchical structure of protocols is defined.

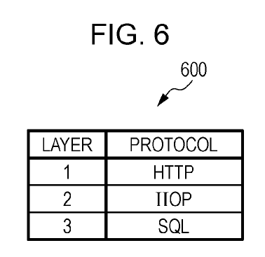

The hierarchical structure of protocols may be defined in the system in advance. Alternatively, hierarchical structure definition information (see FIG. 6) may be input by a user by operating the keyboard 410 or the mouse 411 illustrated in FIG. 4. When the hierarchical structure definition information is input, the hierarchical structure definition information is obtained by the obtaining unit 501, and the hierarchical structure of protocols is defined.

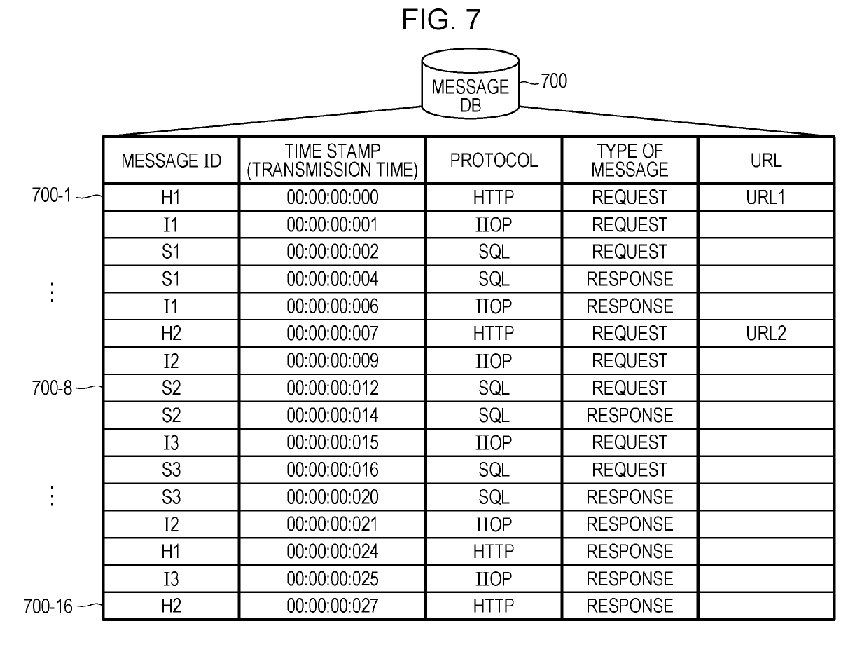

The message data group may be obtained by extracting from a message DB 700 (see FIG. 7) that stores analysis results generated by the message analyzing unit 220. Alternatively, the message data group may be directly input to the system analyzing apparatus 101 by a user by operating the keyboard 410 or the mouse 411 illustrated in FIG. 4, or may be obtained from an external computer apparatus.

Here, the capture unit 210 captures packets transmitted/received among the computer apparatuses in the system via the switches provided in the system (e.g., the switches S1 to S3 illustrated in FIG. 2). The message analyzing unit 220 analyzes a message in a packet captured by the capture unit 210.

The message analyzing unit 220 reconfigures message data transmitted/received among the computer apparatuses in the system by using the packet data 300-1 to 300-m stored in the packet DB 230. The message analyzing process of analyzing packets and reconfiguring a message is a known art, and thus the description thereof is omitted here (e.g., see Japanese Laid-open Patent Publication No. 2006-11683).

Now, the hierarchical structure definition information defining the hierarchical structure of protocols is described. FIG. 6 illustrates an example of the hierarchical structure definition information. Referring to FIG. 6, the hierarchical structure of protocols of the network system 100 is defined in the hierarchical structure definition information 600. For example, “HTTP” is defined in the first layer as the highest layer, “IIOP” is defined in the second layer, and “SQL” is defined in the third layer as the lowest layer.

Next, the content stored in the message DB 700, which stores analysis results generated by the message analyzing unit 220, is described. FIG. 7 illustrates the content stored in the message DB 700. Referring to FIG. 7, the message DB 700 stores message data 700-1 to 700-16 transmitted/received among the computer apparatuses in the network system 100. FIG. 7 illustrates part of the message data transmitted/received among the computers.

The message data 700-1 to 700-16 includes information about a message ID, a transmission time (e.g., hour: minute: second), a protocol, a type of message, and a URL. The message ID is an identifier to identify the message. The transmission time is the time when the message is transmitted. The type of message is information to indicate whether the message is a request message or a response message. The URL is designated by the browser installed in the client terminal 105. The URL is included only in a request message transmitted/received with the use of the protocol in the highest layer (e.g., the message data 700-1).

For example, the fact that a request message having a message ID “S2” was transmitted from the AP server 103 to the DB server 104 by using SQL (third layer) at the transmission time “00:00:00.012” can be recognized from the message data 700-8. The source and destination computer apparatuses can be identified on the basis of the protocol and the type of message. For example, when the protocol is “HTTP” and when the type of message is “request”, the source computer apparatus is the client terminal 105 whereas the destination computer apparatus is the web server 102.

Referring back to FIG. 5, the detecting unit 502 detects pairs of a request message and a response message of the same message ID from the message data group obtained by the obtaining unit 501. The detecting unit 502 detects arbitrary message data from the message data group.

On the basis of the message ID of the detected message data, the detecting unit 502 searches the message data group for message data of the same message ID. If message data of the same message ID is found, the message data is identified.

Accordingly, a pair of a request message and a response message of the same message ID may be detected. The above-described procedure is repeatedly performed until there is no message data undetected in the message data group, so that all the pairs are detected in the message data group.

For example, assume that the message data 700-1 is detected in the message data 700-1 to 700-16. In this case, the searching unit searches for the message data of the message ID “H1” in the remaining message data 700-2 to 700-16. Then, a pair of a request message and a response message of the message ID “H1” is detected in the message data 700-14.

The identifying unit 503 identifies the request time and the response time of each pair detected by the detecting unit 502. In each pair, the transmission time of the request message is identified as the request time, and the transmission time of the response message is identified as the response time.

For example, in the pair of the message ID “H1.” the transmission time “00:00:00.000” in the message data 700-1 is identified as the request time, whereas the transmission time “00:00:00.024” in the message data 700-14 is identified as the response time.

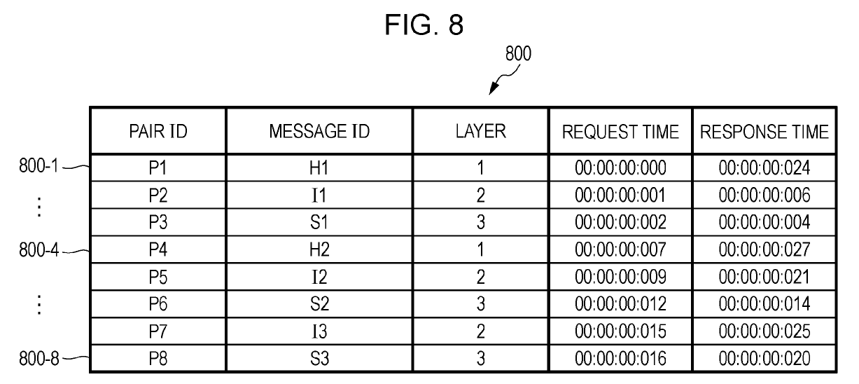

Now, a pair information table to store processing results generated by the detecting unit 502 and the identifying unit 503 is described. FIG. 8 illustrates an example of the pair information table. Referring to FIG. 8, the pair information table 800 includes pair information 800-1 to 800-8 of pairs P1 to P8 detected in the message data 700-1 to 700-16 illustrated in FIG. 7.

Each of the pair information 800-1 to 800-8 of the pairs P1 to P8 includes information about a pair ID, a message ID, a layer, a request time, and a response time. The “pair ID” is an identifier to identify the pair. The “message ID” is a unique message ID of the pair. The “layer” indicates the protocol unique to the pair. The “request time” and the “response time” represent a request time and a response time of the pair.

For example, the pair information 800-4 includes the pair ID “P4”, the message ID “H2”, the layer “first layer (HTTP)”, the request time “00:00:00.007”, and the response time “00:00:00.027”.

Referring back to FIG. 5, the searching unit 504 searches for a child-layer pair on the basis of the identification result generated by the identifying unit 503. The child-layer pair means a pair that has a request time and a response time between the request time and the response time of a pair arbitrarily selected from among the pairs detected by the detecting unit 502 (hereinafter referred to as a “parent-layer pair”), and that has a protocol of a layer lower than the protocol of the parent-layer pair.

By referring to the pair information table 800 illustrated in FIG. 8, the searching unit 504 may search for a child-layer pair that has a request time and a response time between the request time and the response time of a parent-layer pair arbitrarily selected from among the pairs P1 to P8 and that has a protocol in the layer immediately under the protocol of the parent-layer pair.

At this time, a pair may be arbitrarily selected as a parent-layer pair from among the pairs P1, P2, P4, P5, and P7, but is not selected from among the pairs P3, P6, and P8 having the protocol in the lowest layer. Accordingly, a wasteful process of searching for a pair in the layer lower than the lowest layer (non-existing pair) can be reduced.

Now, an outline of the searching process performed by the searching unit 504 is described. Here, a description is given about a searching process of searching for a child-layer pair that has a request time and a response time between the request time and the response time of a parent-layer pair arbitrarily selected from among the pairs P1 to P8, and that has a protocol of the layer immediately under the protocol of the parent-layer pair, with reference to the pair information table 800.

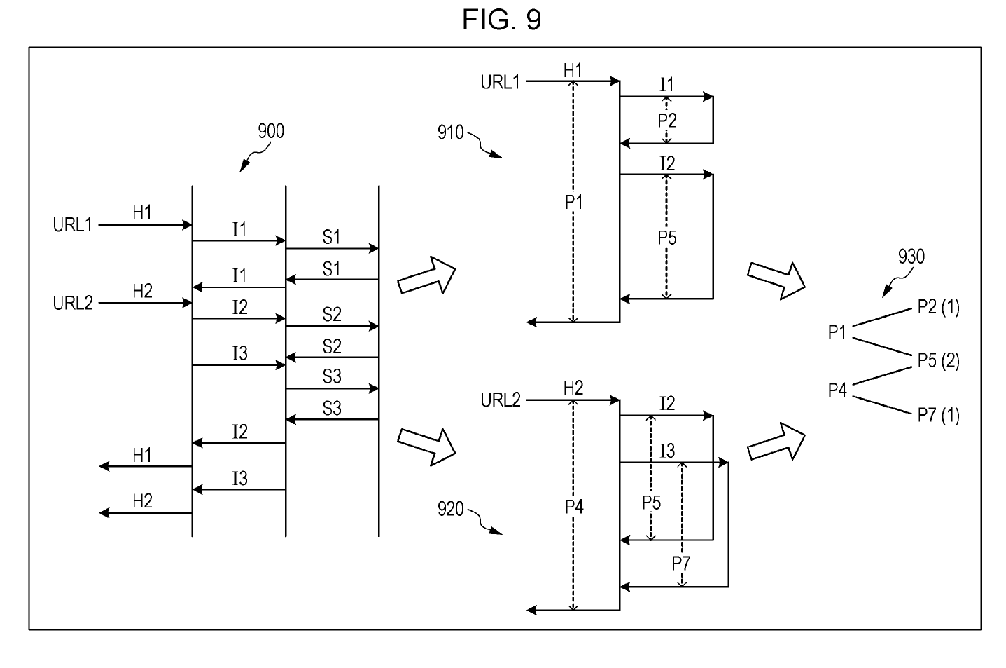

FIG. 9 illustrates the outline of the searching process. FIG. 9 includes a sequence graph 900 showing a time-series flow of messages among the computer apparatuses in the network system 100. In FIG. 9, right-pointing arrows indicate request messages, whereas left-pointing arrows indicate response messages. Also, message IDs of the respective messages are indicated above the respective arrows.

The sequence graph 900 illustrates a time-series flow of all the messages identified in the message data 700-1 to 700-16. Also, URL1 and URL2 designated by the browser installed in the client terminal 105 are shown in the request messages in the highest layer (first layer).

The searching unit 504 arbitrarily selects parent-layer pairs P1 and P4 in the highest layer from among the pairs P1 to P8 with reference to the pair information table 800. The searching unit 504 searches for child-layer pairs that have a request time and a response time between the request time and the response time of the selected parent-layer pairs P1 and P4, and that have a protocol (IIOP) in the layer immediately under the protocol (HTTP) of the parent-layer pairs P1 and P4.

The searching unit 504 searches for and finds the child-layer pairs P2 and P5 in the second layer that have a request time and a response time between the request time “00:00:00.000” and the response time “00:00:00.024” of the parent-layer pair P1 in the first layer. As a result, parent-child relationships between the parent-layer pair P1 in the first layer and the child-layer pairs P2 and P5 in the second layer are analyzed (see graph 910).

Here, the parent-child relationship means a call relationship where a process request to a computer apparatus of a protocol in a lower layer (e.g., AP server 103) occurs in accordance with a process request to a computer apparatus of a protocol in a higher layer (e.g., web server 102).

In the graph 910, the request times and the response times of the pairs P2 and P5 are between the request time and the response time of the pair P1. Thus, parent-child relationships between the parent-layer pair P1 and the child-layer pairs P2 and P5 are formed. The child-layer pairs P2 and P5 are candidate pairs having a call relationship with the parent-layer pair P1. This is because each of the child-layer pairs P2 and P5 can form a parent-child relationship with a parent-layer pair other than the parent-layer pair P1.

Likewise, the searching unit 504 finds the child-layer pairs P5 and P7 in the second layer that have a request time and a response time between the request time “00:00:00.007” and the response time “00:00:00.027” of the parent-layer pair P4 in the first layer. As a result, parent-child relationships between the parent-layer pair P4 in the first layer and the child-layer pairs P5 and P7 in the second layer are analyzed (see graph 920).

In the graph 920, the request times and the response times of the pairs P5 and P7 are between the request time and the response time of the pair P4, which forms parent-child relationships between the parent-layer pair P4 and the child-layer pairs P5 and P7. In this case, the child-layer pair P5 forms parent-child relationships with both the parent-layer pairs P1 and P4, and is thus a candidate pair that forms call relationships with both the parent-layer pairs P1 and P4.

Although not illustrated, after the search for the parent-layer pairs P1 and P4 in the first layer ends, the process shifts to the second layer under the first layer, parent-layer pairs P2, P5, and P7 in the second layer are arbitrarily selected from among the pairs P1 to P8, and the respective parent-child relationships are analyzed. The series of processes are repeated until there is no unselected pair in all the layers except the lowest layer (e.g., third layer).

Accordingly, parent-child relationships between adjoining layers can be analyzed. A graph 930 depicts parent-child relationships between the parent-layer pairs in the first layer and the child-layer pairs in the second layer. The number attached to the child-layer pairs P2, P5, and P7 is the number of candidate parent-layer pairs having a call relationship.

The number of candidate parent-layer pairs having a call relationship with the respective child-layer pairs is counted by the counting unit 507 on the basis of the search result generated by the searching unit 504. Here, the child-layer pair P5 has parent-child relationships with both the parent-layer pairs P1 and P4, and thus the number of candidate parent-layer pairs having a call relationship is 2.

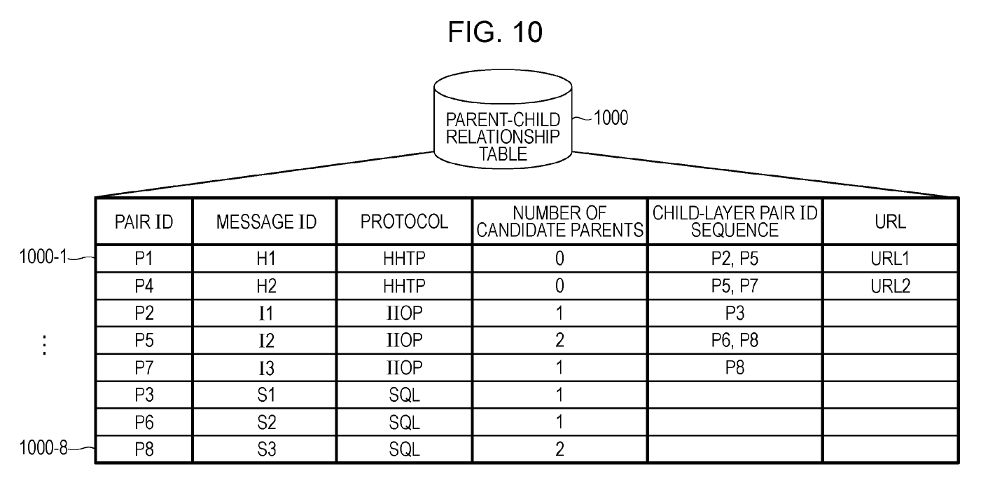

Now, a parent-child relationship table storing the search results generated by the searching unit 504 is described. FIG. 10 illustrates content stored in the parent-child relationship table. Referring to FIG. 10, the parent-child relationship table 1000 stores parent-child information 1000-1 to 1000-8 of the pairs P1 to P8.

Each of the parent-child information 1000-1 to 1000-8 of the pairs P1 to P8 has information about a pair ID, message ID, a protocol, the number of candidate parents, a child-layer pair ID sequence, and a URL. Here, the number of candidate parents is the number of candidate parent-layer pairs having a call relationship. The child-layer pair ID sequence indicates the pair ID of one or more child-layer pairs having a call relationship.

For example, the parent-child information 1000-1 of the pair P1 illustrated in FIG. 9 has information of the message ID “H1”, the number of candidate parents “0” (because the pair P1 is in the highest layer), the child-layer pair ID sequence “P2, P5”, and the URL “URL1” designated by the browser installed in the client terminal 105.

By referring to the parent-child relationship table 1000, a search for progeny-layer pairs from pairs in the highest layer to pairs in the lowest layer may be conducted. On the basis of the child-layer pair ID sequence of a parent-layer pair in the highest layer, a search for a child-layer pair may be conducted. Similarly, a search for a grandchild-layer pair may be conducted based on the child-layer pair ID sequence of the child-layer pair.

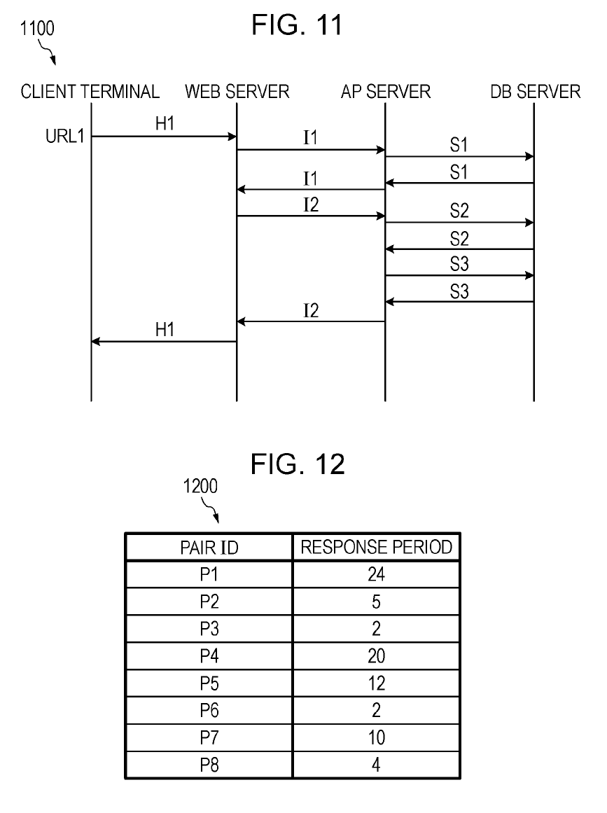

The output unit 508 outputs the child-layer pairs found by the searching unit 504 as candidate pairs having a call relationship with a parent-layer pair. The output unit 508 may search for call relationships in the pairs in the highest layer to the lowest layer found by the searching unit 504, so as to output a transaction model representing the call relationships of messages from the highest layer to the lowest layer. FIG. 11 illustrates an example of the transaction model.

FIG. 11 illustrates a transaction model 1100 of a time-series flow of messages transmitted/received among the computer apparatuses in the network system 100. According to the transaction model 1100, a candidate message that is generated by the designation of “URL1” in the browser of the client terminal 105 can be identified.

Referring back to FIG. 5, the first calculating unit 505 calculates a response period from a request to a response of each of a parent-layer pair and a child-layer pair by using the request time and the response time of each pair identified by the identifying unit 503.

For example, the first calculating unit 505 can calculate the response period of each of the pairs P1 to P8 by calculating the difference between the request time and the response time of each of the pairs P1 to P8 by referring to the pair information table 800. For example, in the pair P1, the first calculating unit 505 can calculate the response period of the pair P1 (24 ms) by subtracting the request time from the response time of the pair information 800-1.

Now, a response period table storing the calculation results generated by the first calculating unit 505 is described. FIG. 12 illustrates an example of the response period table. In FIG. 12, the response period table 1200 shows the response period [ms] from a request to a response of each of the pairs P1 to P8.

The second calculating unit 506 calculates a processing period of a server that is a destination of a request message of a parent-layer pair on the basis of the response period of the parent-layer pair and the child-layer pair calculated by the first calculating unit 505. The second calculating unit 506 may calculate the processing period of the server that is a destination of the request message of the parent-layer pair by subtracting the response period of the child-layer pair from the response period of the parent-layer pair by referring to the parent-child relationship table 1000 and the response period table 1200.

At this time, when there are a plurality of candidate parents having a call relationship with the child-layer pair, the response period of the child-layer pair that is to be subtracted from the response period of the parent-layer pair is replaced with a value calculated by dividing the response period by the number of candidate parents. Accordingly, the response period of the child-layer pair is evenly allocated to the plurality of parent-layer pairs having a parent-child relationship.

That is, when there are a plurality of parent-layer pairs having a parent-child relationship, the parent-layer pair that actually has a call relationship is unknown. Thus, the value calculated by dividing the response period of the child-layer pair by the number of candidate parents is allocated to the respective parent-layer pairs, whereby the processing period of the above-described server is obtained.

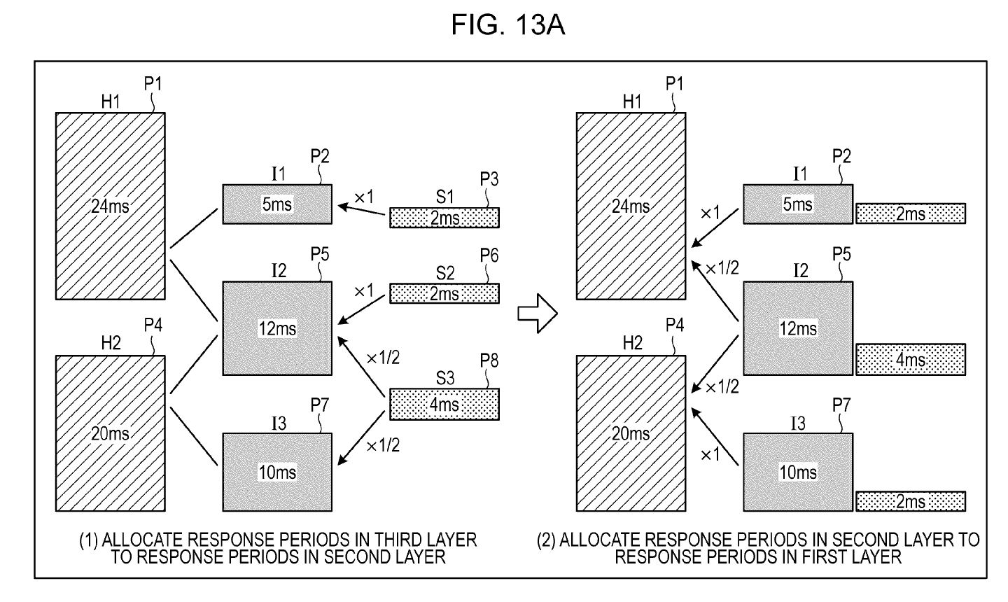

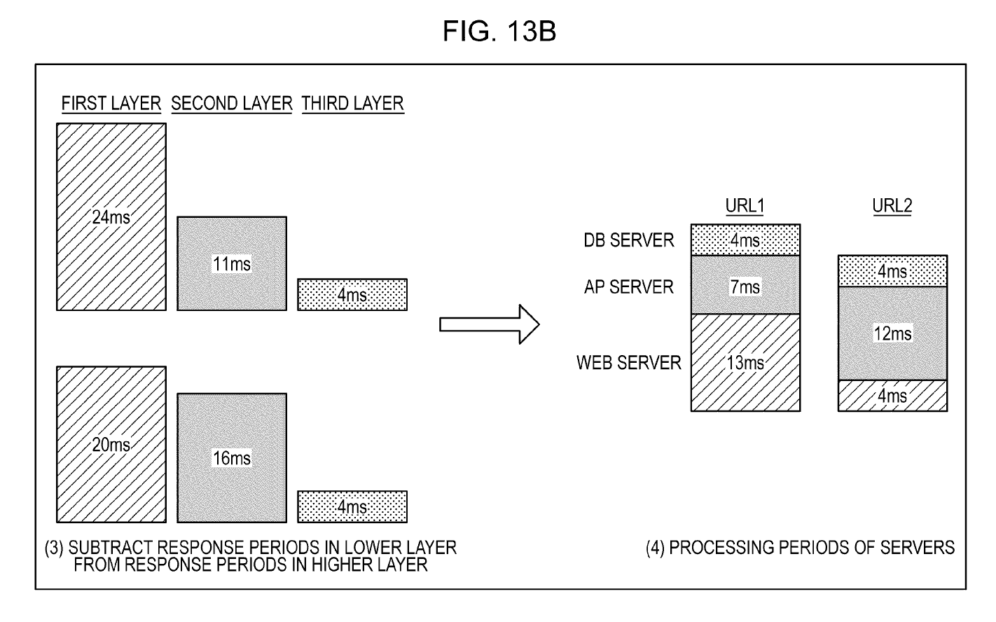

Now, an outline of a calculating process of calculating a processing period of a server is described. FIGS. 13A and 13B illustrate the outline of the calculating process of calculating the processing period of the server. Here, assume that the progeny-layer pairs (child layer: second layer; grandchild layer: third layer) of the parent-layer pairs P1 and P4 in the first layer have been found on the basis of a search result generated by the searching unit 504.

Referring to FIG. 13A, the response periods in the third layer which is the lowest layer are allocated to the response periods in the second layer (1). The response period of the pair P3 in the third layer is allocated to the response period of the pair P2 in the second layer. Also, the response period of the pair P6 in the third layer is allocated to the response period of the pair P5 in the second layer. Since the pair P8 in the third layer has parent-child relationships with the pairs P5 and P7 in the second layer, the value calculated by dividing the response period of the pair 8 by 2 (the number of candidates) is allocated to each of the response periods of the pairs P5 and P7.

The response periods in the second layer are allocated to the response periods in the first layer (2). For example, the response period of the pair P2 in the second layer is allocated to the response period of the pair P1 in the first layer. Since the pair P5 in the second layer has parent-child relationships with the pairs P1 and P4 in the first layer, the value calculated by dividing the response period of the pair P5 by 2 (the number of candidates) is allocated to each of the response periods of the pairs P1 and P4. Also, the response period of the pair P7 in the second layer is allocated to the response period of the pair P4 in the first layer.

Referring to FIG. 13B, the response period in the lower layer is subtracted from the response period in the adjoining upper layer, whereby the processing period of the server that is a destination of the request message in the upper layer is calculated (3). The response period in the second layer is subtracted from the response period in the first layer, whereby the processing period of the web server 102 is calculated. Also, the response period in the third layer is subtracted from the response period in the second layer, whereby the processing period of the AP server 103 is calculated. Since the third layer is the lowest layer, the response period in the third layer corresponds to the processing period of the DB server 104.

Accordingly, the processing periods of the web server 102, the AP server 103, and the DB server 104 in the network system 100 can be calculated (4). For example, in “URL1”, the processing period of the web server 102 is 13 ms, the processing period of the AP server 103 is 7 ms, and the processing period of the DB server 104 is 4 ms.

The output unit 508 outputs the processing periods of the respective servers calculated by the second calculating unit 506. The output unit 508 may output a table showing a list of processing periods of the respective servers (e.g., web server 102, AP server 103, and DB server 104) calculated by the second calculating unit 506.

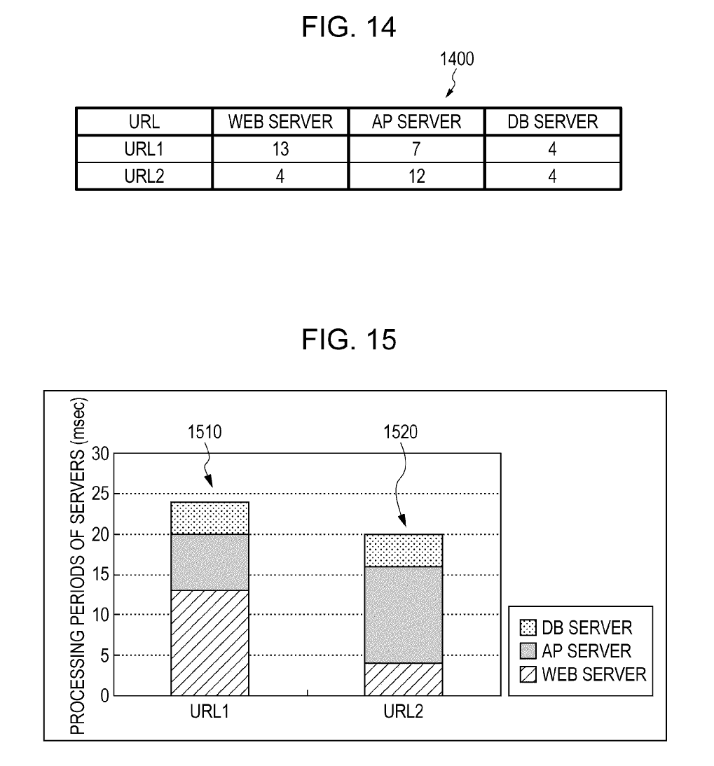

FIG. 14 illustrates a first example of an output result. Referring to FIG. 14, a processing period table 1400 shows a list of processing periods of the web server 102, the AP server 103, and the DB server 104 in the network system 100 for the URL1 and URL2. With this table, the processing periods of the web server 102, the AP server 103, and the DB server 104 when URL1 and URL2 are designated can be recognized.

Alternatively, the output unit 508 may display, on the display 408, a bar graph showing the details of the processing periods of the respective servers with respect to the entire processing period. FIG. 15 illustrates a second example of the output result.

FIG. 15 is a bar graph including bars 1510 and 1520 illustrating the details of the processing periods of the web server 102, the AP server 103, and the DB server 104 with respect to the entire processing period for URL1 and URL2. With this graph, the processing periods of the web server 102, the AP server 103, and the DB server 104 when URL1 and URL2 are designated may be intuitively recognized.

The output results illustrated in FIGS. 14 and 15 represent the processing periods when URL1 and URL2 are designated, and are thus estimated to have larger variations compared to actual processing periods. In such a case, errors may be reduced by arbitrarily designating a time slot to which a system analyzing process is applied and by calculating the average of the processing periods in the time slot (time unit).

In this case, the obtaining unit 501 obtains a message data group included in a designated time slot (e.g., “00:00:00.000” to “23:59:59.999”). As a result, a system analyzing process for the designated time slot is performed. The above-described time slot may be arbitrarily designated by a user by operating the keyboard 410 or the mouse 411 illustrated in FIG. 4.

The second calculating unit 506 may calculate an average processing period of the server that is a destination of a request message of the parent-layer pair in the arbitrarily designated time slot. For example, the second calculating unit 506 may calculate the average processing period of the respective servers by totaling the processing periods of the respective servers in the designated time slot (e.g., “00:00:00.000” to “23:59:59.999”) for each URL and by calculating the average thereof The URL can be identified from the request message of the protocol in the highest layer.

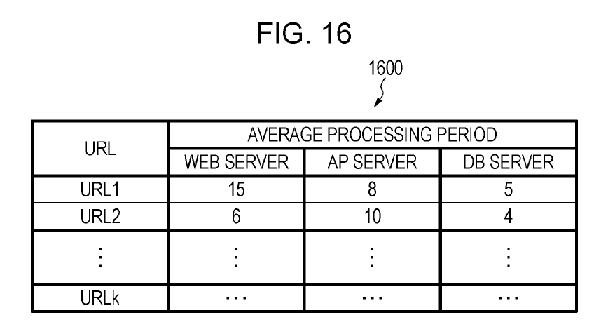

FIG. 16 illustrates a third example of the output result. Referring to FIG. 16, a processing period table 1600 shows a list of average processing periods of the web server 102, the AP server 103, and the DB server 104 in the network system 100 in each of URL1 to URLk.

With this table, statistical processing periods of the web server 102, the AP server 103, and the DB server 104 in an arbitrarily designated time slot can be recognized. As a result, for example, a server with a high load (web server 102 in this case) can be identified and the cause of degradation in performance may be quickly determined. Although not illustrated, a bar graph showing the output result illustrated in FIG. 16 may be displayed on the display 408 (see FIG. 15).

According to the embodiment, the capture unit 210 and the message analyzing unit 220 are provided in the system analyzing apparatus 101, but may be provided in an external computer apparatus. In that case, the obtaining unit 501 may obtain a message data group from the external computer apparatus. (Procedure of system analyzing process in system analyzing apparatus)

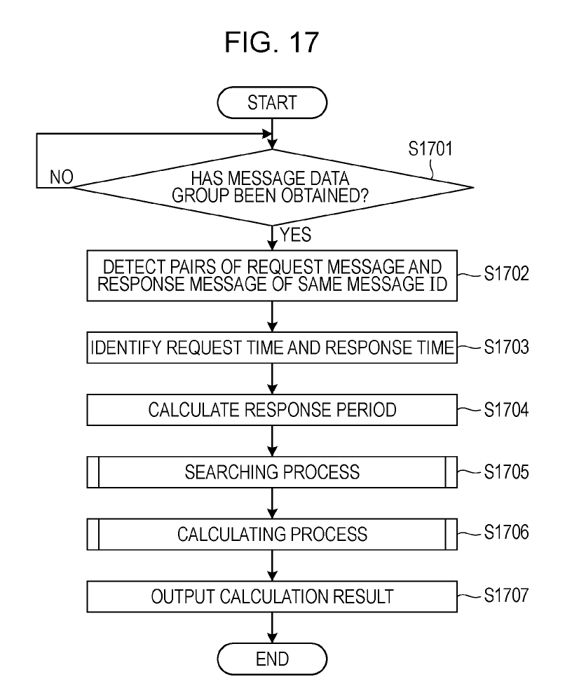

Hereinafter, a procedure of a system analyzing process performed in the system analyzing apparatus 101 according to the embodiment is described. FIG. 17 is a flowchart illustrating an example of the procedure of the system analyzing process. First, the obtaining unit 501 determines whether it has obtained a message data group transmitted/received among the computer apparatuses in the system (step S1701).

The obtaining unit 501 waits for the acquisition of a message data group (NO in step S1701). After the obtaining unit 501 has obtained a message data group (YES in step S1701), the detecting unit 502 detects pairs of a request message and a response message of the same message ID from the obtained message data group (step S1702).

The identifying unit 503 identifies the request time and the response time of each of the detected pairs on the basis of the transmission time in the message data (step S1703). The first calculating unit 505 calculates a response period from a request to a response of each of a parent-layer pair and a child-layer pair by using the identified request time and response time of each pair (step S1704).

On the basis of the identification result generated by the identifying unit 503, the searching unit 504 searches for a child-layer pair that has a request time and a response time between the request time and the response time of a parent-layer pair selected from among the pairs, and that has a protocol in a layer lower than the protocol of the parent-layer pair (step S1705).

The second calculating unit 506 calculates a processing period of a server that is a source of the request message of the parent-layer pair on the basis of the calculated response periods of the parent-layer pair and child-layer pair (step S1706). The output unit 508 outputs a calculation result (step S1707), and the process is completed.

Next, a procedure of the searching process in step S1705 illustrated in FIG. 17 is described. Hereinafter, in the hierarchical structure of protocols defined in the system, the highest layer is the first layer, the lowest layer is the N-th layer, and an arbitrarily selected layer is the n-th layer (n=1, 2, . . . , N).

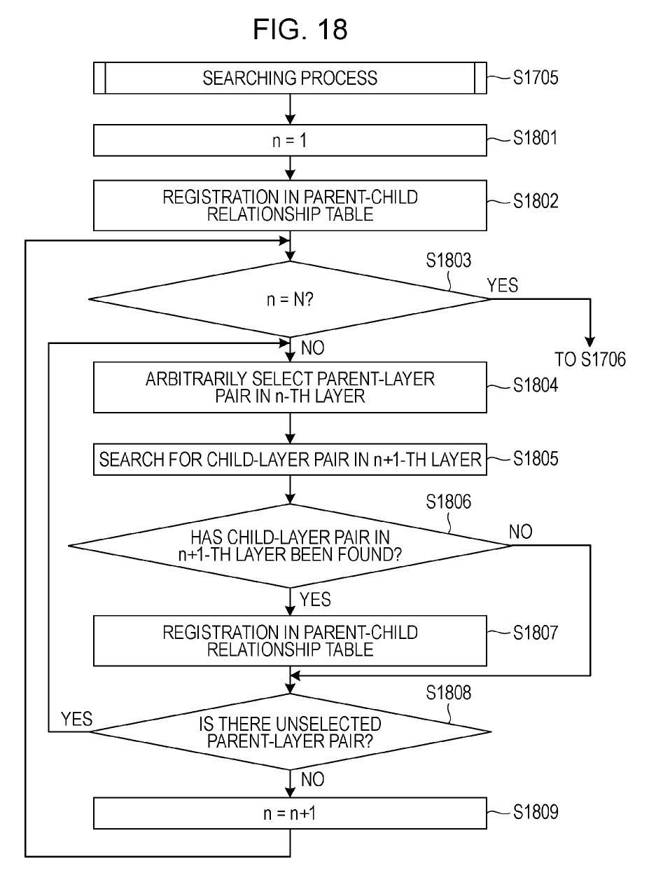

FIG. 18 is a flowchart illustrating a procedure of the searching process. The searching unit 504 sets n=1 (step S1801), and registers the pair ID, message ID, protocol, and URL of each pair in the n-th layer (n=1) in the parent-child relationship table (step S1802).

The searching unit 504 determines whether n=N (step S1803). If n≠N (NO in step S1803), the searching unit 504 arbitrarily selects a parent-layer pair in the n-th layer from among the pairs detected in step S1702 in FIG. 17 (step S1804). The searching unit 504 searches for a child-layer pair in the n+1-th layer that has a request time and a response time between the request time and the response time of the selected parent-layer pair (step S1805).

The searching unit 504 determines whether a child-layer pair in the n+1-th layer has been found (step S1806). If no child-layer pair in the n+1-th layer has been found (NO in step S1806), the process proceeds to step S1808.

On the other hand, if a child-layer pair in the n+1-th layer has been found (YES in step S1806), the searching unit 504 registers the pair ID of the found child-layer pair in the corresponding entry of the parent-layer pair in the parent-child relationship table and also registers the pair ID, the message ID, and the protocol of the child-layer pair in the parent-child relationship table (step S1807). At this time, if the pair ID, the message ID, and the protocol of the child-layer pair have already been registered, the counting unit 507 increases the number of candidate parents of the of the child-layer pair by 1.

The searching unit 504 determines whether there is an unselected parent-layer pair in the n-th layer from among the pairs (step S1808). If there is an unselected parent-layer pair (YES in step S1808), the process returns to step S1804, and the series of steps are repeated.

On the other hand, if there is no unselected parent-layer pair (NO in step S1808), the searching unit 504 sets n=n+1 (step S1809), and the process returns to step S1803. If n=N (YES in step S1803), the process shifts to step S1706 in FIG. 17.

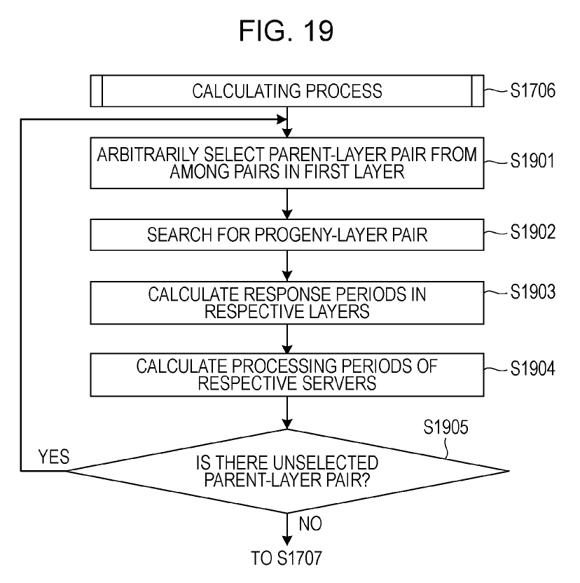

Next, a procedure of the calculating process in step S1706 illustrated in FIG. 17 is described. FIG. 19 is a flowchart illustrating a procedure of the calculating process. First, the second calculating unit 506 arbitrarily selects a parent-layer pair in the first layer from among the pairs detected in step S1702 in FIG. 17 (step S1901).

The second calculating unit 506 searches for a progeny-layer pair of the selected parent-layer pair by referring to the child-layer pair ID sequence in the parent-child relationship table (step S1902). The second calculating unit 506 calculates the response periods in the respective layers by allocating the response periods in a lower layer to the response periods in an adjoining upper layer by referring to the response period table (step S1903).

The second calculating unit 506 calculates the processing periods of the respective servers by subtracting the response period in a lower layer from the response period in an adjoining upper layer (step S1904). The second calculating unit 506 determines whether there is an unselected parent-layer pair in the first layer from among the pairs (step S1905).

If there is an unselected parent-layer pair in the first layer (YES in step S1905), the process returns to step S1901, and the second calculating unit 506 repeats the process. On the other hand, if there is no unselected parent-layer pair in the first layer (NO in step S1905), the process shifts to step S1707 in FIG. 17.

As described above, according to the embodiment, one skilled in the art may analyze an operation status of each server in the system without creating a transaction model in advance. A parent-child relationship among messages can be analyzed from the message data group transmitted/received in the system, and the processing periods of the respective servers can be estimated on the basis of the analysis result and the response periods of the respective messages.

Accordingly, one skilled in the art can recognize the processing periods of the servers when the respective URLs are designated. Also, by totaling the processing periods of the servers of requests that occur in a certain time unit (e.g., in units of hours or in units of days) for each URL, an average processing period of each server for each URL can be statistically calculated, so that the accuracy of system analysis can be improved. As a result, a server with a high load and a server not operating may be identified, and thus the cause of a degradation in performance or a failure may be quickly determined.

Furthermore, specific information of messages transmitted/received in the system and the knowledge and know-how for creating a transaction model are not required, and thus introduction costs for system analysis can be reduced compared to the conventional system analysis.

The system analyzing method according to the embodiment may be implemented by allowing a computer, such as a personal computer or a work station, to execute a prepared program. The program may be recorded on a computer-readable recording medium, such as a hard disk, a flexible disk, a CD-ROM, an MO, or a DVD, and may be executed by a computer by being read from the recording medium. The program may also be a medium that can be distributed via a network, such as the Internet.

What is claimed is:

1. A computer-readable recording medium storing a system analyzing program containing instructions executed on a computer, the program causing the computer to execute:
an obtaining procedure which obtains a message data group including a message ID, a protocol, a type, and a transmission time of a message transmitted/received in a system where a hierarchical structure of protocols is defined;
a detecting procedure which detects a pair of a request message and a response message with the same message ID from the obtained message data group;
an identifying procedure which identifies a request time and a response time of each of the detected pairs;
a searching procedure which searches for a child-layer pair that has a request time and a response time between the request time and the response time of a parent-layer pair arbitrarily selected from among the pairs and that has a protocol in a layer lower than the protocol of the parent-layer pair on the basis of an identification result generated in the identifying procedure; and
an outputting procedure which outputs the found child-layer pair as a candidate pair having a call relationship with the parent-layer pair.

2. The computer-readable recording medium according to claim 1, wherein the searching procedure searches for a child-layer pair of the protocol in the layer immediately under the protocol of the parent-layer pair.

3. The computer-readable recording medium according to claim 1, the program further causing the computer to execute:
a first calculating procedure which calculates a response period from a request to a response of each parent-layer pair and each child-layer pair by using the identified request time and response time of each of the pairs; and
a second calculating procedure which calculates a processing period of a server that is a destination of a request message of the parent-layer pair on the basis of the response periods of the parent-layer pair and the child-layer pair calculated in the first calculating procedure,
wherein the outputting procedure outputs the processing period of the server calculated in the second calculating procedure.

4. The computer-readable recording medium according to claim 3, wherein, if the protocol of the child-layer pair is in the lowest layer, the outputting procedure outputs the response period of the child-layer pair as a processing period of the server that is a destination of a request message of the child-layer pair.

5. The computer-readable recording medium according to claim 3, the program further causing the computer to execute:
a counting procedure which counts the number of candidates of parent-layer pairs having a call relationship with the child-layer pair on the basis of a search result generated in the searching procedure,
wherein the second calculating procedure calculates the processing period of the server that is the destination of the request message of the parent-layer pair on the basis of the response periods of the parent-layer pair and the child-layer pair calculated in the first calculating procedure and the number of candidates counted in the counting procedure.

6. The computer-readable recording medium according to claim 5,
wherein the searching procedure repeatedly executes a searching process until there is no parent-layer pair selected from among the remaining pairs of protocols except the protocol in the lowest layer, and
wherein the counting procedure counts the number of candidates of parent-layer pairs having a call relationship with the child-layer pair on the basis of a search result generated in the searching procedure.

7. The computer-readable recording medium according to claim 1,
wherein the parent-layer pair is a pair arbitrarily selected from among the remaining pairs of protocols except the protocol in the lowest layer among the pairs.

8. The computer-readable recording medium according to claim 3,
wherein the second calculating procedure calculates an average processing period of the server by totaling processing periods of the server that is the destination of the request message of the parent-layer pair when an address in an arbitrarily designated time slot is designated for each address identified by the request message of the protocol in the highest layer, and
wherein the outputting procedure outputs the average processing period of the server calculated in the second calculating procedure.

9. The computer-readable recording medium according to claim 8,
wherein the second calculating procedure calculates an average processing period of the server by totaling the processing periods of the server that is the destination of the request message of the child-layer pair in the lowest layer if the address in the time slot is designated.

10. The computer-readable recording medium according to claim 9,
wherein the outputting procedure outputs, for each address, the processing period of the server that is the destination of the request message of the protocol in each layer from the highest layer to the lowest layer if the address is designated.

11. A system analyzing apparatus comprising:
obtaining means for obtaining a message data group including a message ID, a protocol, a type, and a transmission time of a message transmitted/received in a system where a hierarchical structure of protocols is defined;
detecting means for detecting a pair of a request message and a response message of the same message ID from the obtained message data group;
identifying means for identifying a request time and a response time of each of the detected pairs;
searching means for searching for a child-layer pair that has a request time and a response time between the request time and the response time of a parent-layer pair arbitrarily selected from among the pairs and that has a protocol in a layer lower than the protocol of the parent-layer pair on the basis of a identification result generated by the identifying means; and
outputting means for outputting the found child-layer pair as a candidate pair having a call relationship with the parent-layer pair.

12. A system analyzing method executed by a computer, the method comprising:
obtaining a message data group including a message ID, a protocol, a type, and a transmission time of a message transmitted/received in a system where a hierarchical structure of protocols is defined;
detecting pairs of a request message and a response message of the same message ID from the obtained message data group;
identifying a request time and a response time of each of the detected pairs;
searching for a child-layer pair that has a request time and a response time between the request time and the response time of a parent-layer pair arbitrarily selected from among the pairs and that has a protocol in a layer lower than the protocol of the parent-layer pair on the basis of a identification result generated in the identifying; and
outputting the found child-layer pair as a candidate pair having a call relationship with the parent-layer pair.
